(19) United States
(12) Patent Application Publication
(10) Pub. No.: US 2015/0028219 A1
(43) Pub. Date: Jan. 29, 2015

(54) WORKPIECE WITH MARKING

(71) Applicant: Polysecure GmbH, Freiburg (DE)

(72) Inventors: Thomas Baque, Freiburg (DE); Jochen Moesslein, Freiburg (DE)

(73) Assignee: Polysecure GmbH, Freiburg (DE)

(21) Appl. No.: 14/379,941

(22) PCT Filed: Feb. 8, 2013
(86) PCT No.: PCT/DE2013/000075

§ 371 Date: Aug. 20, 2014

(30) Foreign Application Priority Data
Feb. 24, 2012 (DE) 102012003519.5

(51) Int. Cl. G09F 3/02; G01N 23/223; G01N 21/64; G09F 7/16; G01N 21/84

(52) U.S. Cl. CPC G09F 3/02; G09F 7/165; G01N 21/84; G01N 21/6447; G01N 23/223; G09F 2003/0276
USPC 250/395; 427/275; 428/172

(57) ABSTRACT

The present invention relates to a workpiece which, on its surface, displays a depression having an opening width of at least 0.2 mm and in which depression a carrier material which is connected in a substantially inseparable manner to the workpiece and contains a characteristic marking material for the workpiece is disposed; and to a method for manufacturing the same and to a method for authentication and/or identification of the workpiece.

### TECHNICAL FIELD

The present invention relates to a workpiece having a marking, a method for manufacturing the same, and a method for authentication and/or identification of the workpiece.

### BACKGROUND

It is a known fact that technical and other high-value products are often copied without authorization, causing great damage to the individual enterprises and, moreover, to the entire economy. In addition, the copied products are often of inferior quality. Since the customer is unaware of the fake, any potential deficiencies are projected onto the inferior quality of the brand, consequently also causing enormous damage to the image of the manufacturers.

On account of the technical possibilities nowadays many repetition parts, such as machinery parts, for example, can be copied in at least a macroscopically practically perfect manner. It is therefore often difficult if not even impossible to differentiate between original products from plagiarized products, such that original products, for the purpose of differentiation, have to be hallmarked in a targeted, effective and economic manner with additional features.

This marking of workpieces, however, is not only of significance for differentiating between original products and plagiarized products; marking of workpieces is also becoming increasingly relevant when sorting (comminuted or broken-up) workpieces during recycling.

In the field of expertise the most varied methods for marking materials and workpieces and for protection against fakes, or for identifying fakes, respectively, have been described.

As per the prior art, for hallmarking workpieces above all labels may be attached on the surface of the workpiece. For actual hallmarking, such labels then have to have open or obscured security features which can be verified and/or measured in an unequivocal and reproducible manner. Security features may be a specific pattern, for example bar codes, holograms, micrographics, a specific color, an electronic item of information, for example in the case of RFID chips, and much more.

Markings applied on the surface, such as labels or printed items, however, have the disadvantage that they are comparatively sensitive to mechanical and chemical attacks on the surface and may be detached or damaged by corresponding stress. Furthermore, on account of their accessibility, labels can often be copied, such that no effective protection against plagiarized products exists.

Markings which are embedded in the workpiece, or the basic material, respectively, show significant advantages, but are not applicable in all cases. Such marking systems cannot be employed, in particular, in metals, glass or ceramics where high melting temperatures can destroy the marking agent, or in workpieces which are manufactured from commercially available semi-finished products, for example metal profiles.

### SUMMARY

It is an object of the present invention to provide a workpiece having a marking system which overcomes the disadvantages of the prior art. In particular, the marking system is to be able to be employed in the workpiece, which is preferably constructed from metal, ceramic, wood, plastic and/or glass, in the smallest space and should preferably not significantly compromise the overall impression of the workpiece. Furthermore, despite the marking, the workpiece should be able to be processed during recycling such that the marking material can be destroyed prior to and/or during recycling, in order to avoid a distribution of the marking material, via the recycling streams, onto new products manufactured therefrom.

Beyond this, it is an object of the present invention to provide a method for manufacturing a workpiece according to the invention, and a method for authentication and/or identification of such a workpiece.

### DETAILED DESCRIPTION

The first object is achieved by a workpiece which, on its surface, displays a depression having an opening width of at least 0.2 mm and in which depression a carrier material which is connected in a substantially inseparable manner to the workpiece and contains a characteristic marking material for the workpiece is disposed.

The workpiece according to the invention is surprisingly particularly distinguished in that a carrier material containing a marking material is connected in a substantially inseparable manner to the workpiece, in that the carrier material containing the marking material is received in a depression which is incorporated into the surface of the workpiece. This depression displays an opening width of at least 0.2 mm, the shape of the depression, however, being arbitrary. The depression may be implemented, for example, as a circular bore. An embossing is likewise conceivable, for example in the shape of a company logo. The depression may display perpendicular or slightly inclined side walls, such as, for example, in the shape of an undercut having a dove-tail shape. Corresponding measures for introducing the depression on the surface of the workpiece are well known in the field of expertise.

A substantially inseparable connection between the workpiece and the carrier material, according to the invention, is to be understood as a connection which cannot be released without destroying the workpiece and/or the carrier material. An opening width of the depression disposed on the workpiece of at least 0.2 mm is required in order for a simple analysis of the marking material by means of electromagnetic radiation to take place in a method for authentication and/or identification of the workpiece, and in order for a fundamentally adequate face to be present onto which electromagnetic radiation can enter and/or from which electromagnetic radiation, for example fluorescence, can be emitted.

The workpiece according to the invention overcomes the disadvantages associated with marking by way of labels, i.e. in particular being easily detachable or damaged, since, in the workpiece according to the invention, the carrier material containing the marking material is connected to the workpiece in a substantially inseparable manner and is located in a more or less protected manner on the workpiece, for example in a depression having an undercut.

In comparison to the marking of a workpiece, in which corresponding marking material is mixed into the material of the workpiece itself during manufacturing thereof, the workpiece according to the invention displays the further advantage that, during recycling of the workpiece, the carrier material containing the marking material can then be destroyed without any major problems, in order to avoid a distribution of the marking material, via the recycling streams, onto new products made therefrom. In order to achieve this purpose, depending on the material of the workpiece, suitable materials for the carrier material and the marking material may be selected which, in a particular property, differ from the material of the workpiece. For example, if workpieces according to the invention produced from aluminum are subjected to a recycling process, processing of the aluminum thus requires a temperature of about 1000° C. For marking such a workpiece a carrier material and marking material which are already destroyed at a temperature of up to 800° C., for example, may then be selected, such that they do not become involved in the recycling stream. In this case, exemplary carrier materials are, of course, the polymer compounds mentioned below, for example, which cannot withstand temperatures of 800° C. The selection of marking materials may also be suitably adapted such that the marking material is also decomposed/destroyed at temperatures of below 1000° C.

It is preferable for the workpiece to be made from metal, glass, wood, plastic and/or ceramic.

It is also preferably provided that the depression displays a depth of 0.1-5 mm, preferably 0.5-1 mm, and/or the depression displays an opening width of 1-4 mm.

A preferred embodiment is distinguished in that the carrier material is introducible into the depression in a liquid or pasty form and is then curable in the depression. Therefore, the carrier material introduced into the depression may assume the shape of a drop.

It is preferable here that the carrier material is selected from the group composed of glass and polymer compounds such as epoxy resin, polyester resin, polyether resin, silicone resin and/or phenolic resin.

It is likewise particularly preferable, according to the invention, that the marking material is selected from the group composed of Stokes pigments and/or Anti-Stokes pigments, ceramic markers, preferably having a chemical code, or a material which has a characteristic which can be differentiated from the carrier material and/or the basic material.

It may also be provided that, on the surface of the depression, a pretreatment agent for improving adhesion is applied.

The second object is achieved by a method for manufacturing a workpiece as claimed in one of the preceding claims, characterized in that it comprises the steps of:
a) introducing a depression having a width of at least 0.2 mm into the surface of a workpiece;
b) introducing a carrier material, which contains a characteristic marking material for the workpiece, in liquid or pasty form into the depression;
c) curing and connecting the carrier material in a substantially inseparable manner to the workpiece.

The substantially inseparable connection between the carrier material containing the marking material and the workpiece is essential for manufacturing the workpiece according to the invention. A curable polymer composition into which the marking material can initially be introduced, preferably dissolved, is particularly preferably used as a carrier material. The carrier material containing the marking material is then introduced into the depression prepared in the workpiece, which may take place manually or also automatically. The introduced carrier material may then cure in the depression.

As a marking material, in particular compositions may be considered which show Stokes radiation behavior or Anti-Stokes radiation behavior, ceramic markers, preferably having a chemical code, as they are known from WO 2010/066237, for example, or any other material which displays a characteristic property which differentiates the marking material from the surrounding carrier material and/or the workpiece.

The carrier material, apart from the marking material, may of course contain other suitable materials, such as dyes or fillers, for example.

The introduction of the liquid or pasty carrier material may take place such that in relation to the workpiece the carrier material, after curing, is present so as to be flush with the surface, depressed or proud. After curing, the surface of the workpiece including the carrier material may be further processed with established methods, such as grinding, polishing, etc.

Finally, according to the invention, a method for authentication and/or identification of a workpiece is provided comprising the steps of:
i) qualitative and/or quantitative reading of the marking material; and
ii) matching the reading result obtained in step i) with stored items of authentication and/or identification information for the workpiece.

A workpiece according to the invention provided with a marking material may be employed in a simple manner in the method described above in that the marking material or the marking agent, respectively, is read using suitable detectors.

If Stokes or Anti-Stokes compositions are employed as marking materials, after corresponding radiation with electromagnetic radiation of suitable wavelength, a simple camera is sufficient for checking whether corresponding fluorescent effects can be detected.

When using a ceramic marker known in the field of expertise, having a chemical code, which is set based on a qualitative and quantitative distribution of metals, detection by way of x-ray fluorescence analysis may take place.

The features of the invention disclosed in the above description and in the claims may be significant individually and also in any arbitrary combination for the implementation of the invention in its various embodiments.

1. A workpiece which, on its surface, displays a depression having an opening width of at least 0.2 mm and in which depression a carrier material which is connected in a substantially inseparable manner to the workpiece and which contains a characteristic marking material for the workpiece is disposed.

2. The workpiece as claimed in claim 1, wherein the workpiece is made from metal, glass, wood, plastic and/or ceramic.

3. The workpiece as claimed in claim 1, characterized in that the depression displays a depth of 0.1-5 mm.

4. The workpiece as claimed in claim 1, wherein the carrier material is introducible into the depression in a liquid or pasty form and is then curable in the depression.

5. The workpiece as claimed in claim 4, wherein the carrier material is selected from glass and polymer compounds.

6. The workpiece as claimed in claim 1, wherein the marking material is selected from Stokes pigments and/or Anti-Stokes pigments, ceramic markers, and a material which has a characteristic which can be differentiated from the carrier material.

7. The workpiece as claimed in claim 1, wherein, on the surface of the depression, a pretreatment agent for improving adhesion is applied.

8. A method for manufacturing a workpiece as claimed in claim 1, wherein said method comprises the steps of:
a) introducing a depression having an opening width of at least 0.2 mm into the surface of a workpiece;
b) introducing a carrier material, which contains a characteristic marking material for the workpiece, in liquid or pasty form into the depression;
c) curing and connecting the carrier material in a substantially inseparable manner to the workpiece.

9. A method for authentication and/or identification of a workpiece as claimed in claim 1, comprising the steps of:
i) qualitative and/or quantitative reading of the marking material; and
ii) matching the reading result obtained in step i) with stored items of authentication and/or identification information for the workpiece.

10. The workpiece as claimed in claim 5, wherein the polymer compounds is epoxy resin, polyester resin, polyether resin, silicone resin and/or phenolic resin.

11. The workpiece as claimed in claim 2, wherein the carrier material is introducible into the depression in a liquid or pasty form and is then curable in the depression.

12. The workpiece as claimed in claim 11, wherein the carrier material is selected from glass and polymer compounds.

13. The workpiece as claimed in claim 12, wherein the polymer compounds is epoxy resin, polyester resin, polyether resin, silicone resin and/or phenolic resin.
